(19) United States
(12) Patent Application Publication
(10) Pub. No.: US 2013/0314385 A1
(43) Pub. Date: Nov. 28, 2013

(54) METHOD OF DIGITAL-DRIVING AN ORGANIC LIGHT EMITTING DISPLAY DEVICE

(71) Applicant: SAMSUNG DISPLAY CO., LTD., Yongin-City (KR)

(72) Inventor: Do-Ik Kim, Yongin-City (KR)

(73) Assignee: SAMSUNG DISPLAY CO., LTD., Yongin-City (KR)

(21) Appl. No.: 13/661,158

(22) Filed: Oct. 26, 2012

(30) Foreign Application Priority Data
May 24, 2012 (KR) 10-2012-0055388

(51) Int. Cl. G09G 3/30; G06F 3/038

(52) U.S. Cl. 345/204; 345/76

(57) ABSTRACT

A method of digital-driving an organic light emitting display device, which divides one frame into a plurality of sub-frames and displays one frame by displaying the plurality of sub-frames, is provided. In the method, a sub-frame emission order for odd scan-lines is set to be a first order, a sub-frame emission order for even scan-lines is set to be the first order, a scan direction for the odd scan-lines is set to be a first direction, a scan direction for the even scan-lines is set to be a second direction with the second direction being opposite of the first direction, each sub-frame scan timing of the odd scan-lines is shifted by a first time, and each sub-frame scan timing of the even scan-lines is shifted by a second time.

### CROSS-REFERENCE TO RELATED APPLICATION(S)

This application claims priority under 35 USC §119 to Korean Patent Applications No. 10-2012-0055388, filed on May 24, 2012 in the Korean Intellectual Property Office (KIPO), the contents of which are incorporated herein in its entirety by reference. Furthermore, the present application is related to a co-pending U.S. application, Ser. No. ______, entitled METHOD OF DIGITAL-DRIVING AN ORGANIC LIGHT EMITTING DISPLAY DEVICE, based upon Korean Application No. 10-2012-0055919, filed on May 25, 2012 in the Korean Intellectual Property Office (KIPO).

### BACKGROUND OF THE INVENTION

1. Field of the Invention

Example embodiments relate generally to a method of driving an organic light emitting display device. More particularly, embodiments of the inventive concept relate to a method of digital-driving an organic light emitting display device.

2. Description of the Related Art

Recently, an organic light emitting display device is widely used as a flat display device as an electric device is getting smaller and consuming lower power consumption. Generally, an organic light emitting display device displays a specific gray level using a voltage stored in a storage capacitor of each pixel (i.e., an analog driving technique for an organic light emitting display device). However, the analog driving technique may not accurately display a desired gray level because the analog driving technique uses the voltage (i.e., an analog value) stored in the storage capacitor of each pixel.

To overcome this problem, a digital driving technique for an organic light emitting display device has been suggested. In detail, the digital driving technique displays one frame by displaying a plurality of sub-frames. That is, in the digital driving technique, one frame is divided into a plurality of sub-frames, each emission time of the sub-frames is differently set (e.g., by a factor of 2), and a specific gray level is displayed using a sum of emission times of the sub-frames.

Typically, the digital driving technique sequentially performs scan operations of all scan-lines for each sub-frame, and then simultaneously performs emission operations of all scan-lines for each sub-frame. Alternatively, the digital driving technique randomly performs scan operations of all scan-lines for each sub-frame by shifting each sub-frame scan timing of the scan-lines by a specific time, and thus randomly (i.e., separately) performs emission operations of all scan-lines for each sub-frame. As a result, the digital driving technique may result in a dynamic false contour noise due to an emission time difference between the most significant bits (MSB) and the least significant bits (LSB) when a specific gray level is implemented.

### SUMMARY OF THE INVENTION

Some example embodiments provide a method of digital-driving an organic light emitting display device capable of minimizing (or, preventing) a dynamic false contour noise due to an emission time difference between the most significant bits (MSB) and the least significant bits (LSB) when a specific gray level is implemented.

According to some example embodiments, a method of digital-driving an organic light emitting display device, which divides one frame into a plurality of sub-frames and displays one frame by displaying the plurality of sub-frames, may include a step of setting a sub-frame emission order for odd scan-lines and a sub-frame emission order for even scan-lines to be a first order, a step of setting a scan direction for the odd scan-lines to be a first direction, a step of setting a scan direction for the even scan-lines to be a second direction, the second direction being opposite of the first direction, a step of shifting each sub-frame scan timing of the odd scan-lines by a first time, and a step of shifting each sub-frame scan timing of the even scan-lines by a second time.

In example embodiments, each of the sub-frames may correspond to each bit of a data signal, and a gray level may be implemented based on a sum of emission times of the sub-frames.

In example embodiments, a sub-frame having the longest emission time among the sub-frames may correspond to the most significant bit of the data signal, and a sub-frame having the shortest emission time among the sub-frames may correspond to the least significant bit of the data signal.

In example embodiments, the first time and the second time may be determined to spatially disperse emissions of sub-frames corresponding to the most significant bits of the data signal and emissions of sub-frames corresponding to the least significant bits of the data signal, respectively.

In example embodiments, the first time may be substantially the same as the second time.

In example embodiments, the first time may be different from the second time.

In example embodiments, the first direction may be determined from an upper scan-line to a lower scan-line in the organic light emitting display device, and the second direction may be determined from the lower scan-line to the upper scan-line in the organic light emitting display device.

In example embodiments, the first direction may be determined from a lower scan-line to an upper scan-line in the organic light emitting display device, and the second direction may be determined from the upper scan-line to the lower scan-line in the organic light emitting display device.

In example embodiments, the first order may be determined in order of increasing of the emission times of the sub-frames.

In example embodiments, the first order may be determined in order of decreasing of the emission times of the sub-frames.

According to some example embodiments, a method of digital-driving an organic light emitting display device, which divides one frame into a plurality of sub-frames and displays one frame by displaying the plurality of sub-frames may include a step of setting a scan direction for odd scan-lines and a scan direction for even scan-lines to be a first direction, a step of setting a sub-frame emission order for the odd scan-lines to be a first order, a step of setting a sub-frame emission order for the even scan-lines to be a second direction, the second direction being opposite of the first direction, a step of shifting each sub-frame scan timing of the odd scan-lines by a first time, and a step of shifting each sub-frame scan timing of the even scan-lines by a second time.

In example embodiments, each of the sub-frames may correspond to each bit of a data signal, and a gray level may be implemented based on a sum of emission times of the sub-frames.

In example embodiments, a sub-frame having the longest emission time among the sub-frames may correspond to the most significant bit of the data signal, and a sub-frame having the shortest emission time among the sub-frames may correspond to the least significant bit of the data signal.

In example embodiments, the first time and the second time may be determined to spatially disperse emissions of sub-frames corresponding to the most significant bits of the data signal and emissions of sub-frames corresponding to the least significant bits of the data signal.

In example embodiments, the first time may be substantially the same as the second time.

In example embodiments, the first time may be different from the second time.

In example embodiments, the first order may be determined in order of increasing of the emission times of the sub-frames, and the second order may be determined in order of decreasing of the emission times of the sub-frames.

In example embodiments, the first order may be determined in order of decreasing of the emission times of the sub-frames, and the second order may be determined in order of increasing of the emission times of the sub-frames.

In example embodiments, the first direction may be determined from an upper scan-line to a lower scan-line in the organic light emitting display device.

In example embodiments, the first direction may be determined from a lower scan-line to an upper scan-line in the organic light emitting display device.

Therefore, a method of digital-driving an organic light emitting display device according to example embodiments may spatially disperse emissions of the most significant bits and emissions of the least significant bits by setting a scan direction for odd scan-lines to be opposite of a scan direction for even scan-lines, or by setting a sub-frame emission order for odd scan-lines to be opposite of a sub-frame emission order for even scan-lines. Thus, a dynamic false contour noise due to an emission time difference between the most significant bits and the least significant bits may be minimized when a specific gray level is implemented. As a result, a display panel driving frequency may be reduced in the organic light emitting display device, and a display panel driving timing may be sufficiently achieved in the organic light emitting display device.

### BRIEF DESCRIPTION OF THE DRAWINGS

Illustrative, non-limiting example embodiments will be more clearly understood from the following detailed description taken in conjunction with the accompanying drawings.

FIG. 1A is a diagram illustrating a conventional digital driving technique of a progressive scan manner for an organic light emitting display device.

FIG. 1B is a diagram illustrating a conventional digital driving technique of a random scan manner for an organic light emitting display device.

FIG. 2 is a diagram illustrating an example in which a dynamic false contour noise is caused by conventional digital driving techniques of FIGS. 1A and 1B.

FIG. 3 is a flow chart illustrating a method of digital-driving an organic light emitting display device according to example embodiments.

FIG. 4 is a diagram illustrating an example in which scan-lines (i.e., odd scan-lines and even scan-lines) are scanned by a method of FIG. 3.

FIG. 5A is a diagram illustrating an example in which odd scan-lines are scanned by a method of FIG. 3.

FIG. 5B is a diagram illustrating an example in which even scan-lines are scanned by a method of FIG. 3.

FIG. 6 is a flow chart illustrating a method of digital-driving an organic light emitting display device according to example embodiments.

FIG. 7 is a diagram illustrating an example in which scan-lines (i.e., odd scan-lines and even scan-lines) are scanned by a method of FIG. 6.

FIG. 8A is a diagram illustrating an example in which odd scan-lines are scanned by a method of FIG. 6.

FIG. 8B is a diagram illustrating an example in which even scan-lines are scanned by a method of FIG. 6.

FIG. 9 is a block diagram illustrating an organic light emitting display device according to example embodiments.

FIG. 10 is a block diagram illustrating an electric device having an organic light emitting display device of FIG. 9.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

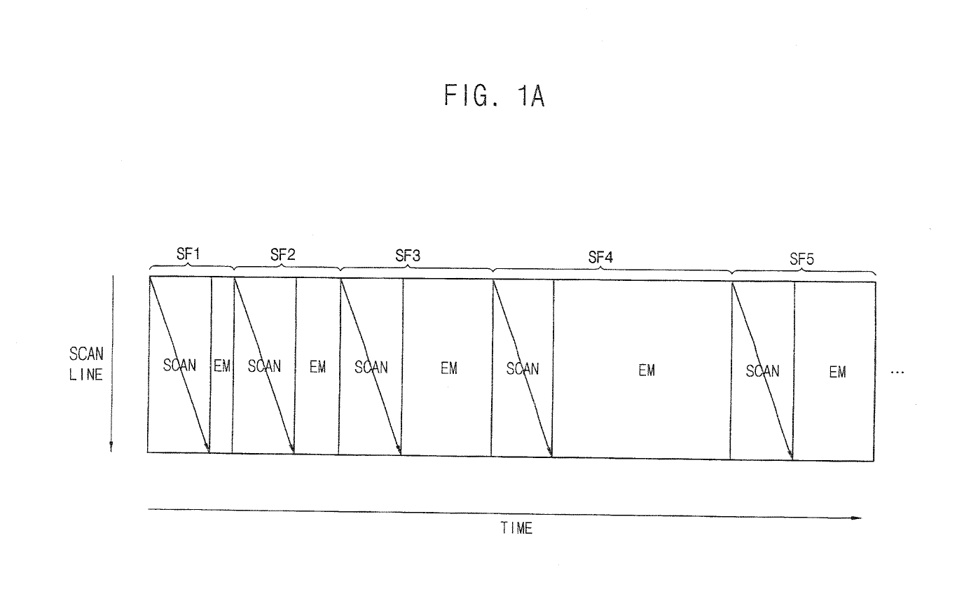

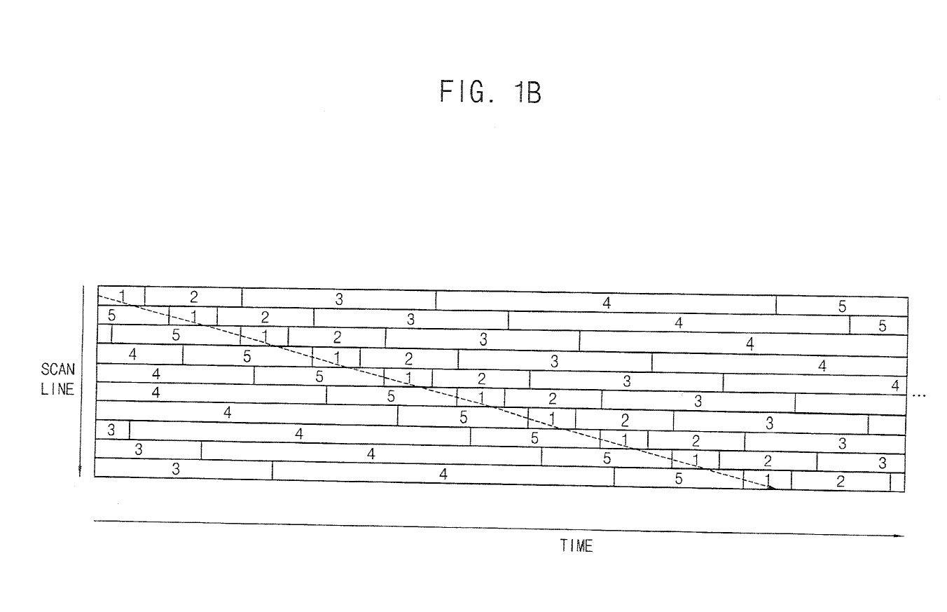

FIG. 1A is a diagram illustrating a conventional digital driving technique of a progressive scan manner for an organic light emitting display device. FIG. 1B is a diagram illustrating a conventional digital driving technique of a random scan manner for an organic light emitting display device.

Referring to FIGS. 1A and 1B, one frame is divided into a plurality of sub-frames. In FIGS. 1A and 1B, it is illustrated that one frame is divided into first through fifth sub-frames SF1, SF2, SF3, SF4, and SF5, with the fifth sub-frame SF5 corresponding to a blank sub-frame. Here, the number of sub-frames constituting one frame may be determined according to required conditions. In addition, the blank sub-frame SF5 may be omitted.

Each sub-frame SF1, SF2, SF3, SF4, and SF5 constituting one frame has a scan time SCAN during which a scan signal is provided to pixels, an emission time EM during which the pixels emit light based on a data signal, and a reset time (not illustrated) during which the pixels are reset (i.e., states of the pixels are changed from an emission state to a non-emission state). In detail, except for the fifth sub-frame SF5 (i.e., the blank sub-frame), each emission time EM of the first through fourth sub-frames SF1, SF2, SF3, and SF4 differs by a factor of 2. That is, each emission time EM of the first through fourth sub-frames SF1, SF2, SF3, and SF4 is differently set. Thus, each emission time EM of the first through fourth sub-frames SF1, SF2, SF3, and SF4 corresponds to each bit of the data signal. For example, as illustrated in FIGS. 1A and 1B, an emission time EM of the second sub-frame SF2 may be twice of an emission time EM of the first sub-frame SF1, an emission time EM of the third sub-frame SF3 may be twice of an emission time EM of the second sub-frame SF2, and an emission time EM of the fourth sub-frame SF4 may be twice of an emission time EM of the third sub-frame SF3. Here, a sub-frame having the longest emission time EM (i.e., the fourth sub-frame SF4) corresponds to the most significant bit (MSB) of the data signal, and a sub-frame having the shortest emission time EM (i.e., the first sub-frame SF1) corresponds to the least significant bit (LSB) of the data signal. As a result, a specific gray level is implemented based on a sum of the emission times EM of the first through fourth sub-frames SF1, SF2, SF3, and SF4.

FIG. 1A shows a conventional digital driving technique of a progressive scan manner for an organic light emitting display device, and FIG. 1B shows a conventional digital driving technique of a random scan manner for an organic light emitting display device. As illustrated in FIG. 1A, the conventional digital driving technique of the progressive scan manner sequentially performs scan operations of all scan-lines (i.e., indicated by arrows crossing SCAN to represent the sequential operations) during scan time SCAN for each sub-frame SF1, SF2, SF3, SF4, and SF5, and simultaneously performs emission operations of all scan-lines (i.e., indicated by no arrow crossing EM to represent simultaneous operations) during emission time EM for each sub-frame SF1, SF2, SF3, SF4, and SF5. Thus, a fast scan operation may be required because an emission time EM for one frame is relatively short. In addition, a dynamic false contour noise due to an emission time difference between the most significant bits and the least significant bits may be initiated when a specific gray level is implemented. As illustrated in FIG. 1B, the conventional digital driving technique of the random scan manner randomly performs scan operations of all scan-lines for each sub-frame 1, 2, 3, 4, and 5 by shifting each sub-frame scan timing of the scan-lines by a specific time, and thus randomly (i.e., separately) performs emission operations of all scan-lines for each sub-frame 1, 2, 3, 4, and 5. Here, a sub-frame emission order of all scan-lines is fixed (e.g., in order of 1, 2, 3, 4, and 5). Thus, the conventional digital driving technique of the random scan manner achieves a sufficient emission time EM compared to the conventional digital driving technique of the progressive scan manner. However, a dynamic false contour noise due to an emission time difference between the most significant hits and the least significant bits may not be prevented when a specific gray level is implemented.

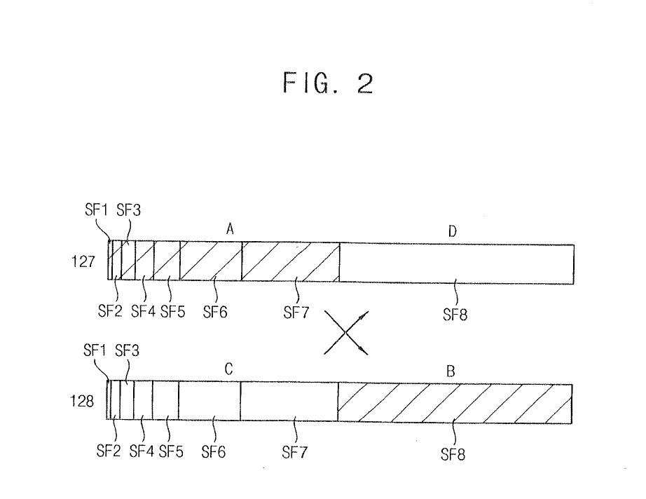

FIG. 2 is a diagram illustrating an example in which a dynamic false contour noise is initiated by conventional digital driving techniques of FIGS. 1A and 1B.

Referring to FIG. 2, it is illustrated that an image is displayed based on 256 gray levels, and one frame is divided into eight sub-frames SF1 through SF8. As described above, the number of sub-frames constituting one frame may be determined according to required conditions. For convenience of descriptions, it is assumed that one frame has no blank sub-frame.

According to the conventional digital driving techniques of FIGS. 1A and 1B, a dynamic false contour noise due to an emission time difference between the most significant bits and the least significant bits may not be prevented. For example, when the 127th gray level is implemented (i.e., displayed), a data signal may correspond to a binary value, “01111111”. Thus, light may be emitted in the first through seventh sub-frames SF1 through SF7, but light may not be emitted in the eighth sub-frame SF8. In addition, when the 128th gray level is implemented displayed), a data signal may correspond to a binary value, “10000000”. Thus, light may not be emitted in the first through seventh sub-frames SF1 through SF7, but light may be emitted in the eighth sub-frame SF8. Here, when a user watches a part (i.e., “A”) representing the 127th gray level and an adjacent part (i.e., “B”) representing the 128th gray level, a user may misperceive it as the 255th gray level. In addition, when a user watches a part (i.e., “C”) representing the 128th gray level and an adjacent part (i.e., “D”) representing the 127th gray level, a user may also misperceive it as the 0th gray level. Therefore, the conventional digital driving techniques of FIGS. 1A and 1B may not prevent a dynamic false contour noise due to an emission time difference between the most significant bits and the least significant bits when a specific gray level is implemented. To overcome this problem, a method of digital-driving an organic light emitting display device according to example embodiments may spatially disperse emissions of the most significant bits and emissions of the most significant bits by setting a scan direction of odd scan-lines to be opposite of a scan direction of even scan-lines, or by setting a sub-frame emission order of odd scan-lines to be opposite of a sub-frame emission order of even scan-lines. Thus, a dynamic false contour noise due to an emission time difference between the most significant bits and the least significant bits may be minimized when a specific gray level is implemented. As a result, a display panel driving frequency may be reduced in the organic light emitting display device, and a display panel driving timing may be sufficiently achieved in the organic light emitting display device. Hereinafter, a method of digital-driving an organic light emitting display device according to example embodiments will be described in detail.

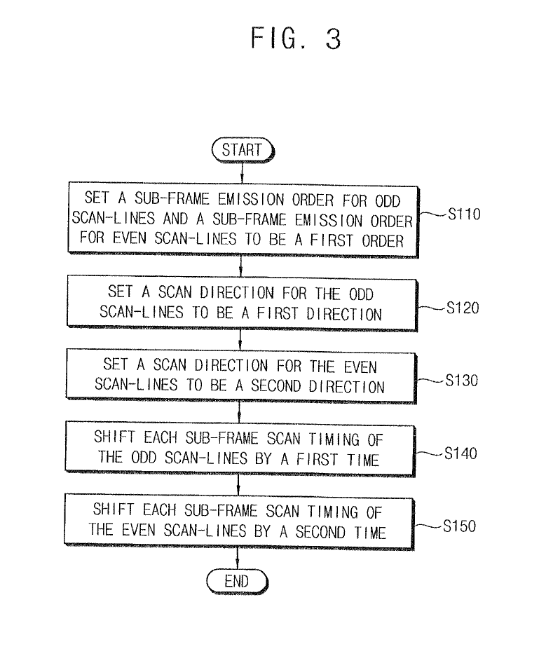

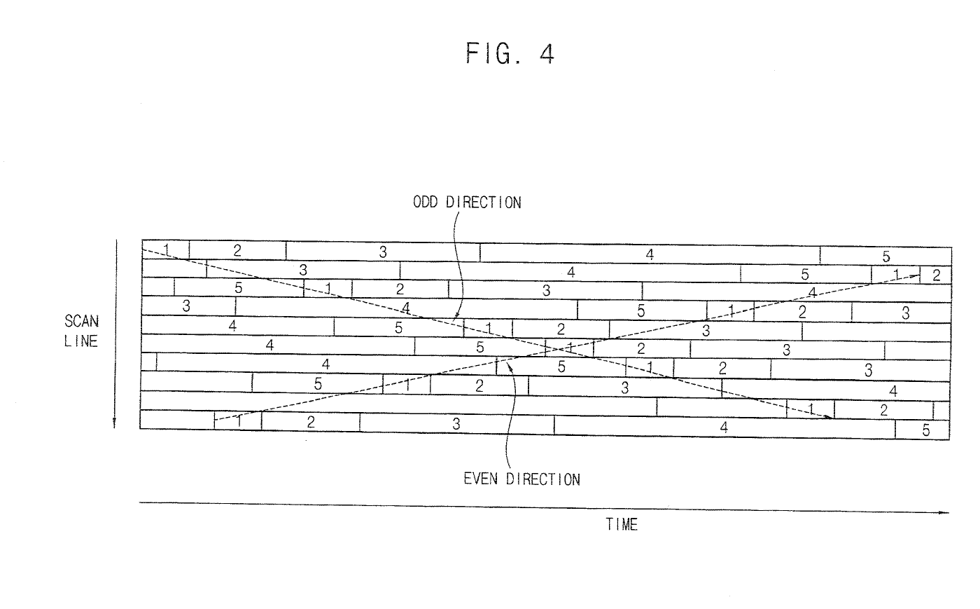

FIG. 3 is a flow chart illustrating a method of digital-driving an organic light emitting display device according to example embodiments. FIG. 4 is a diagram illustrating an example in which scan-lines (i.e., odd scan-lines and even scan-lines) are scanned by a method shown in FIG. 3.

Referring to FIGS. 3 and 4, the method of the digital-driving shown in FIG. 3 may set a sub-frame emission order for odd scan-lines and a sub-frame emission order for even scan-lines to be a first order (Step S110), may set a scan direction for the odd scan-lines to be a first direction (Step S120), and may set a scan direction for the even scan-lines to be a second direction (Step S130). The first direction may be different from the second direction. In an example shown in FIG. 4, the first direction (ODD DIRECTION) and second direction (EVEN DIRECTION) for scan lines are opposite. In addition, the method shown in FIG. 3 may shift each sub-frame scan timing of the odd scan-lines by a first time (Step S140), and may shift each sub-frame scan timing of the even scan-lines by a second time (Step S150). For convenience of descriptions, each sub-frame will be described with reference to each scan-line.

As illustrated in FIG. 4, one frame may be divided into first through fifth sub-frames 1, 2, 3, 4, and 5, with the fifth sub-frame 5 corresponding to a blank sub-frame. Except for the fifth sub-frame 5, each sub-frame 1, 2, 3, and 4 may correspond to each bit of a data signal. A gray level may be implemented based on a sum of emission times of the first through fourth sub-frames 1, 2, 3, and 4. Here, a sub-frame having the longest emission time (i.e., the fourth sub-frame 4) may correspond to the most significant bit of the data signal, and a sub-frame having the shortest emission time (i.e., the first sub-frame 1) may correspond to the least significant bit of the data signal. For example, it is assumed in FIG. 4 that the data signal has a binary value of 4 bits. That is, light may be emitted in the first through fourth sub-frames 1, 2, 3, and 4, but light may not be emitted in the fifth sub-frame 5 (i.e., the blank sub-frame). As described above, the number of sub-frames constituting one frame may be determined according to required conditions. In addition, the blank sub-frame (i.e., the fifth sub-frame 5) may be omitted. A total time of one frame may be divided by a value that is generated by multiplying the number of sub-frames by the number of scan-lines. To implement the gray level, the emission times of the first through fourth sub-frames 1, 2, 3, and 4 may differ by a factor of 2. Thus, if the emission time of the first sub-frame 1 is 3H (H is a horizontal scan interval), the emission time of the second sub-frame 2 may be 6H, the emission time of the third sub-frame 3 may be 12H, and the emission time of the fourth sub-frame 4 may be 24H. Meanwhile, a black color may be displayed in the fifth sub-frame 5 (i.e., the blank sub-frame). For example, if a data signal corresponds to a binary value, “0000”, the 0th gray level may be implemented. In addition, if a data signal corresponds to a binary value, “1111”, the 15th gray level may be implemented.

The method of the digital-driving shown in FIG. 3 may set the sub-frame emission order for the odd scan-lines and the sub-frame emission order for the even scan-lines to be the first order (Step S110). In one example embodiment, as illustrated in FIG. 4, the first order may be determined in order of increasing of the emission times of the first through fourth sub-frames 1, 2, 3, and 4. For example, the sub-frame emission order for the odd scan-lines may be determined as an order of 1, 2, 3, 4, and 5 (i.e., in order of 1, 2, 3, 4, and 5). In addition, the sub-frame emission order for the even scan-lines may be also determined as an order of 1, 2, 3, 4, and 5 (i.e., in order of 1, 2, 3, 4, and 5). In another example embodiment, the first order may be determined in order of decreasing of the emission times of the first through fourth sub-frames 1, 2, 3, and 4. For example, the sub-frame emission order for the odd scan-lines may be determined as an order of 5, 4, 3, 2, and 1 (i.e., in order of 5, 4, 3, 2, and 1). In addition, the sub-frame emission order for the even scan-lines may be also determined as an order of 5, 4, 3, 2, and 1 (i.e., in order of 5, 4, 3, 2, and 1). The method of digital-driving shown in FIG. 3 may set the scan direction for the odd scan-lines to be the first direction (Step S120), and may set the scan direction of the even scan-lines to be the second direction (Step S130). As described above, the first direction may be opposite to the second direction. In one example embodiment, as illustrated in FIG. 4, the first direction may be set as a direction from an upper scan-line to a lower scan-line in the organic light emitting display device, and the second direction may be set as a direction from the lower scan-line to the upper scan-line in the organic light emitting display device. In another example embodiment, the first direction may be set as a direction from the lower scan-line to the upper scan-line in the organic light emitting display device, and the second direction may be set as a direction from the upper scan-line to the lower scan-line in the organic light emitting display device.

In addition, the method of the digital-driving shown in FIG. 3 may shift each sub-frame scan timing of the odd scan-lines by the first time (Step S140), and may shift each sub-frame scan timing of the even scan-lines by the second time (Step S150). Thus, the method of FIG. 3 may spatially disperse emissions of the most significant bits and emissions of the least significant bits by setting the scan direction for the odd scan-lines to be opposite of the scan direction for the even scan-lines while shifting each sub-frame scan timing of the odd scan-lines and each sub-frame scan timing of the even scan-lines. For this operation, the first time by which each sub-frame scan timing of the odd scan-lines is shifted and the second time by which each sub-frame scan timing of the even scan-lines is shifted may be determined to spatially disperse the emissions of the most significant bits and the emissions of the least significant bits. Hence, as illustrated in FIG. 4, the first time may be substantially the same as the second time. Alternatively, the first time may be different from the second time. As described above, since the method of FIG. 3 spatially disperses the emissions of the most significant bits and the emissions of the least significant bits, the method of FIG. 3 may prevent a dynamic false contour noise due to an emission time difference between the most significant bits and the least significant bits when a specific gray level is implemented. In order words, time differences between driving timings of the odd scan-lines and driving timings of the even scan-lines may be randomized. Thus, an artifact (e.g., a horizontal line defect, etc) caused between the odd scan-lines and the even scan-lines may be reduced (or, minimized), and a dynamic false contour noise due to an emission time difference between the most significant bits and the least significant bits may be reduced (or, minimized) when a specific gray level is implemented. As a result, a display panel driving frequency may be reduced in the organic light emitting display device, and a display panel driving timing may be sufficiently achieved in the organic light emitting display device.

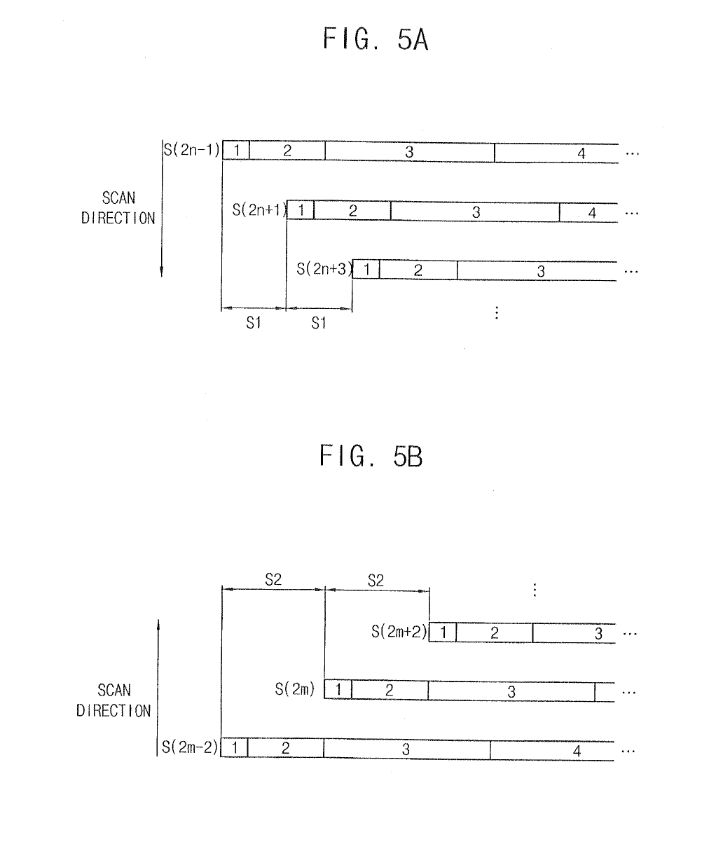

FIG. 5A is a diagram illustrating an example in which odd scan-lines are scanned by a method of FIG. 3. FIG. 5B is a diagram illustrating an example in which even scan-lines are scanned by a method of FIG. 3.

Referring to FIGS. 5A and 5B, it is illustrated that emissions of the most significant bits and emissions of the least significant bits are spatially dispersed by setting the scan direction for the odd scan-lines S(2n−1), S(2n+1), and S(2n+3) to be opposite of the scan direction for the even scan-lines S(2m−2), S(2m), and S(2m+2).

As illustrated in FIGS. 5A and 5B, the sub-frame emission order for the odd scan-lines S(2n−1), S(2n+1), and S(2n+3) may be substantially the same as the sub-frame emission order for the even scan-lines S(2m−2), S(2m), and S(2m+2). In one example embodiment, as illustrated in FIGS. 5A and 5B, the sub-frame emission order for the odd scan-lines S(2n−1), S(2n+1), and S(2n+3) and the sub-frame emission order for the even scan-lines S(2m−2), S(2m), and S(2m+2) may be determined in order of increasing of emission times of the first through fourth sub-frames 1, 2, 3, and 4. In another example embodiment, the sub-frame emission order for the odd scan-lines S(2n−1), S(2n+1), and S(2n+3) and the sub-frame emission order for the even scan-lines S(2m−2), S(2m), and S(2m+2) may be determined in order of decreasing of the emission times of the first through fourth sub-frames 1, 2, 3, and 4. In addition, as illustrated in FIGS. 5A and 5B, the scan direction for the odd scan-lines S(2n−1), S(2n+1), and S(2n+3) may be opposite of the scan direction for the even scan-lines S(2m−2), S(2m), and S(2m+2). In one example embodiment, as illustrated in FIGS. 5A and 5B, the scan direction for the odd scan-lines S(2n−1), S(2n+1), and S(2n+3) may be determined from an upper scan-line to a lower scan-line, and the scan direction for the even scan-lines S(2m−2), S(2m), and S(2m+2) may be determined from the lower scan-line to the upper scan-line. In another example embodiment, the scan direction for the odd scan-lines S(2n−1), S(2n+1), and S(2n+3) may be determined from the lower scan-line to the upper scan-line, and the scan direction for the even scan-lines S(2m−2), S(2m), and S(2m+2) may be determined from the upper scan-line to the lower scan-line.

Further, as illustrated in FIGS. 5A and 5B, each sub-frame scan timing of the odd scan-lines S(2n−1), S(2n+1), and S(2n+3) may be shifted by a first time S1, and each sub-frame scan timing of the even scan-lines S(2m−2), S(2m), and S(2m+2) may be shifted by a second time S2. Here, the first time S1 and the second time S2 may be determined to spatially disperse the emissions of the most significant bits and the emissions of the least significant bits. That is, the first time S1 and the second time S2 may be arbitrarily determined according to required conditions. In one example embodiment, the first time S1 may be substantially the same as the second time S2. In another example embodiment, the first time S1 may be different from the second time S2. As described above, the method of FIG. 3 may spatially disperse the emissions of the most significant bits and the emissions of the least significant bits by setting the scan direction for the odd scan-lines S(2n−1), S(2n+1), and S(2n+3) to be opposite of the scan direction for the even scan-lines S(2m−2), S(2m), and S(2m+2) while shifting each sub-frame scan timing of the odd scan-lines S(2n−1), S(2n+1), and S(2n+3) and each sub-frame scan timing of the even scan-lines S(2m−2), S(2m), and S(2m+2). As a result, a dynamic false contour noise due to an emission time difference between the most significant bits and the least significant bits may be minimized when a specific gray level is implemented.

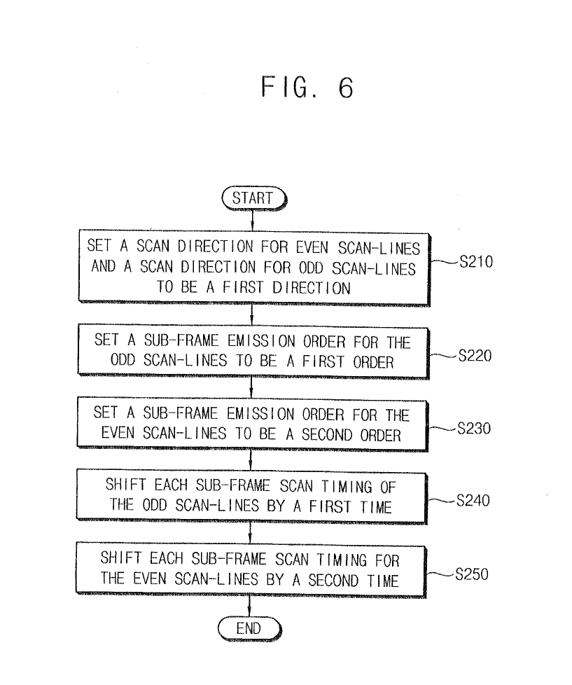

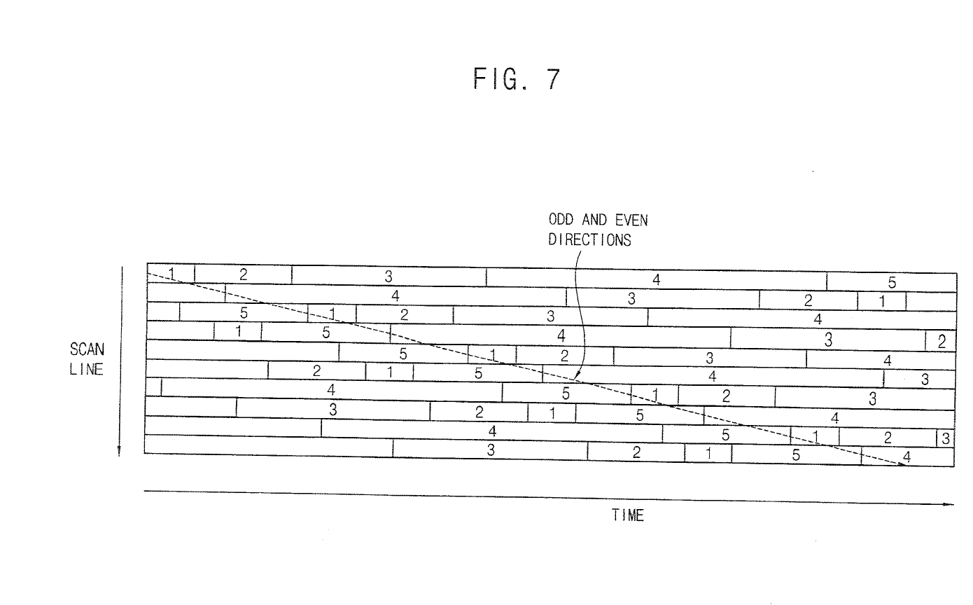

FIG. 6 is a flow chart illustrating a method of digital-driving an organic light emitting display device according to example embodiments. FIG. 7 is a diagram illustrating an example in which scan-lines (i.e., odd scan-lines and even scan-lines) are scanned by a method of FIG. 6.

Referring to FIGS. 6 and 7, the method of the digital-driving shown in FIG. 6 may set a scan direction for even scan-lines and a scan direction for odd scan-lines to be a first direction (Step S210), may set a sub-frame emission order for the odd scan-lines to be a first order (Step S220), and may set a sub-frame emission order for the even scan-lines to be a second order (Step 230). The second order may be opposite to the first order. In addition, the method of the digital-driving shown in FIG. 6 may shift each sub-frame scan timing of the odd scan-lines by a first time (Step S240), and may shift each sub-frame scan timing of the even scan-lines by a second time (Step S250). For convenience of descriptions, each sub-frame will be described with reference to each scan-line.

As illustrated in FIG. 7, one frame may be divided into first through fifth sub-frames 1, 2, 3, 4, and 5, with the fifth sub-frame being a blank sub-frame. Except for the fifth sub-frame 5, each sub-frame 1, 2, 3, and 4 may correspond to each bit of a data signal. The gray level may be implemented based on a sum of emission times of the first through fourth sub-frames 1, 2, 3, and 4. Here, a sub-frame having the longest emission time (i.e., the fourth sub-frame 4) may correspond to the most significant bit of the data signal, and a sub-frame having the shortest emission time (i.e., the first sub-frame 1) may correspond to the least significant bit of the data signal. For example, it is assumed in FIG. 7 that the data signal has a binary value of 4 bits. That is, light may be emitted in the first through fourth sub-frames 1, 2, 3, and 4, but light may not be emitted in the fifth sub-frame 5 (i.e., the blank sub-frame). As described above, the number of sub-frames constituting one frame may be determined according to required conditions. In addition, the blank sub-frame (i.e., the fifth sub-frame 5) may be omitted. A total time of one frame may be divided by a value that is generated by multiplying the number of sub-frames by the number of scan-lines. To implement the gray level, each emission time of the first through fourth sub-frames 1, 2, 3, and 4 may differ by a factor of 2. Thus, if the emission time of the first sub-frame 1 is 3H (H is a horizontal scan interval), the emission time of the second sub-frame 2 may be 6H, the emission time of the third sub-frame 3 may be 12H, and the emission time of the fourth sub-frame 4 may be 24H. Meanwhile, a black color may be displayed in the fifth sub-frame 5 (i.e., the blank sub-frame).

The method of the digital-driving shown in FIG. 6 may set the scan direction for the odd scan-lines and the scan direction for the even scan-lines to be the first direction (Step S210). In one example embodiment, as illustrated in FIG. 7, the first direction may be set as a direction from an upper scan-line to a lower scan-line in the organic light emitting display device. In another example embodiment, the first direction may be set as a direction from the lower scan-line to the upper scan-line in the organic light emitting display device. Here, the method of FIG. 6 may set the sub-frame emission order for the odd scan-lines to be the first order (Step S220), and may set the sub-frame emission order for the even scan-lines to be the second order (Step S230). Here, the first order may be opposite of the second order. In one example embodiment, as illustrated in FIG. 7, the first order may be determined in order of increasing of the emission times of the first through fourth sub-frames 1, 2, 3, and 4, and the second order may be determined in order of decreasing of the emission times of the first through fourth sub-frames 1, 2, 3, and 4. For example, the sub-frame emission order for the odd scan-lines may be determined as an order of 1, 2, 3, 4, and 5 (i.e., in order of 1, 2, 3, 4, and 5), and the sub-frame emission order for the even scan-lines may be determined as an order of 5, 4, 3, 2, and 1 (i.e., in order of 5, 4, 3, 2, and 1). In another example embodiment, the first order may be determined in order of decreasing of the emission times of the first through fourth sub-frames 1, 2, 3, and 4, and the second order may be determined in order of increasing of the emission times of the first through fourth sub-frames 1, 2, 3, and 4. For example, the sub-frame emission order for the odd scan-lines may be determined as an order of 5, 4, 3, 2, and 1 (i.e., in order of 5, 4, 3, 2, and 1), and the sub-frame emission order for the even scan-lines may be determined as an order of 1, 2, 3, 4, and 5 (i.e., in order of 1, 2, 3, 4, and 5).

In addition, the method of the digital-driving shown in FIG. 6 may shift each sub-frame scan timing of the odd scan-lines by the first time (Step S240), and may shift each sub-frame scan timing of the even scan-lines by the second time (Step S250). Thus, the method of FIG. 6 may spatially disperse emissions of the most significant bits and emissions of the least significant bits by setting the sub-frame emission order for the odd scan-lines to be opposite of the sub-frame emission order for the even scan-lines, while shifting each sub-frame scan timing of the odd scan-lines and each sub-frame scan timing of the even scan-lines. For this operation, the first time, by which each sub-frame scan timing of the odd scan-lines is shifted, and the second time, by which each sub-frame scan timing of the even scan-lines is shifted, may be determined to spatially disperse the emissions of the most significant bits and the emissions of the least significant bits. Hence, as illustrated in FIG. 7, the first time may be substantially the same as the second time. Alternatively, the first time may be different from the second time. As described above, since the method of FIG. 6 spatially disperses the emissions of the most significant bits and the emissions of the least significant bits, the method of FIG. 6 may prevent a dynamic false contour noise due to an emission time difference between the most significant bits and the least significant bits when a specific gray level is implemented. Thus, a dynamic false contour noise due to an emission time difference between the most significant bits and the least significant bits may be reduced (or, minimized) when a specific gray level is implemented. As a result, a display panel driving frequency may be reduced in the organic light emitting display device, and a display panel driving timing may be sufficiently achieved in the organic light emitting display device.

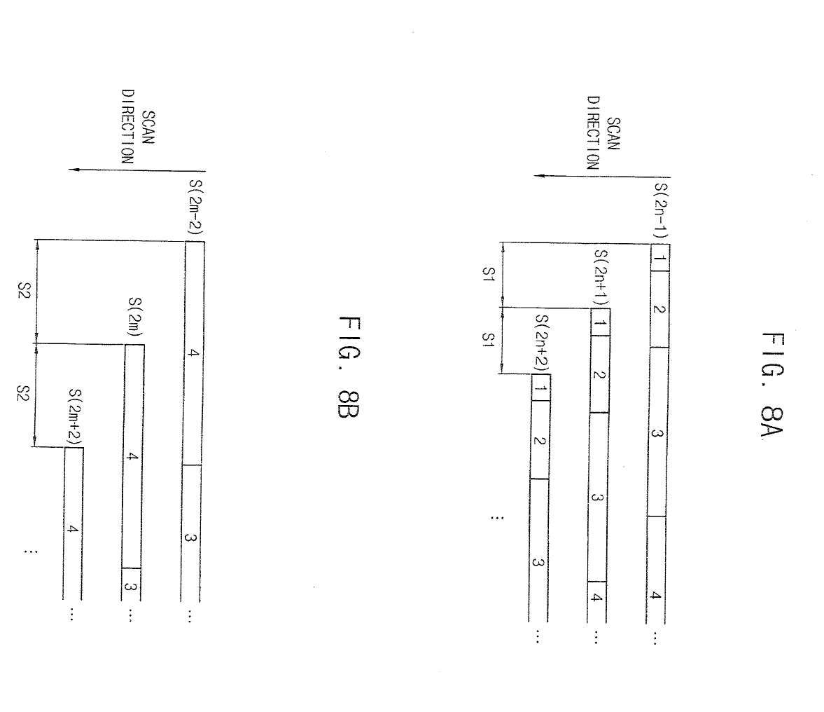

FIG. 8A is a diagram illustrating an example in which odd scan-lines are scanned by a method of FIG. 6. FIG. 8B is a diagram illustrating an example in which even scan-lines are scanned by a method of FIG. 6.

Referring to FIGS. 8A and 8B, it is illustrated that emissions of the most significant bits and emissions of the least significant bits are spatially dispersed by setting the sub-frame emission order for the odd scan-lines S(2n−1), S(2n+1), and S(2n+3) to be opposite of the sub-frame emission order for the even scan-lines S(2m−2), S(2m), and S(2m+2).

As illustrated in FIGS. 8A and 8B, the scan direction for the odd scan-lines S(2n−1), S(2n+1), and S(2n+3) may be substantially the same as the scan direction for the even scan-lines S(2m−2), S(2m), and S(2m+2). In one example embodiment, as illustrated in FIGS. 8A and 8B, the scan direction for the odd scan-lines S(2n−1), S(2n+1), and S(2n+3) and the scan direction for the even scan-lines S(2m−2), S(2m), and S(2m+2) may be set as a direction from an upper scan-line to a lower scan-line in the organic light emitting display device. In another example embodiment, the scan direction for the odd scan-lines S(2n−1), S(2n+1), and S(2n+3) and the scan direction for the even scan-lines S(2m−2), S(2m), and S(2m+2) may be set as a direction from the lower scan-line to the upper scan-line in the organic light emitting display device. In addition, as illustrated in FIGS. 8A and 8B, the sub-frame emission order for the odd scan-lines S(2n−1), S(2n+1), and S(2n+3) may be opposite of the sub-frame emission order for the even scan-lines S(2m−2), S(2m), and S(2m+2). In one example embodiment, as illustrated in FIGS. 8A and 8B, the sub-frame emission order for the odd scan-lines S(2n−1), S(2n+1), and S(2n+3) may be determined in order of increasing of the emission times of the first through fourth sub-frames 1, 2, 3, and 4, and the sub-frame emission order for the even scan-lines S(2m−2), S(2m), and S(2m+2) may be determined in order of decreasing of the emission times of the first through fourth sub-frames 1, 2, 3, and 4. In another example embodiment, the sub-frame emission order for the odd scan-lines S(2n−1), S(2n+1), and S(2n+3) may be determined in order of decreasing of the emission times of the first through fourth sub-frames 1, 2, 3, and 4, and the sub-frame emission order for the even scan-lines S(2m−2), S(2m), and S(2m+2) may be determined in order of increasing of the emission times of the first through fourth sub-frames 1 through 4.

Further, as illustrated in FIGS. 8A and 8B, each sub-frame scan timing of the odd scan-lines S(2n−1), S(2n+1), and S(2n+3) may be shifted by a first time S1, and each sub-frame scan timing of the even scan-lines S(2m−2), S(2m), and S(2m+2) may be shifted by a second time S2. Here, the first time S1 and the second time S2 may be determined to spatially disperse emissions of the most significant bits and emissions of the least significant bits. In one example embodiment, the first time S1 may be substantially the same as the second time S2. In another example embodiment, the first time S1 may be different from the second time S2. As described above, the method of FIG. 6 may spatially disperse the emissions of the most significant bits and the emissions of the least significant bits by setting the sub-frame emission order for the odd scan-lines S(2n−1), S(2n+1), and S(2n+3) to be opposite of the sub-frame emission order for the even scan-lines S(2m−2), S(2m), and S(2m+2) while shifting each sub-frame scan timing of the odd scan-lines S(2n−1), S(2n+1), and S(2n+3) and each sub-frame scan timing of the even scan-lines S(2m−2), S(2m), and S(2m+2). As a result, a dynamic false contour noise due to an emission time difference between the most significant bits and the least significant bits may be minimized when a specific gray level is implemented.

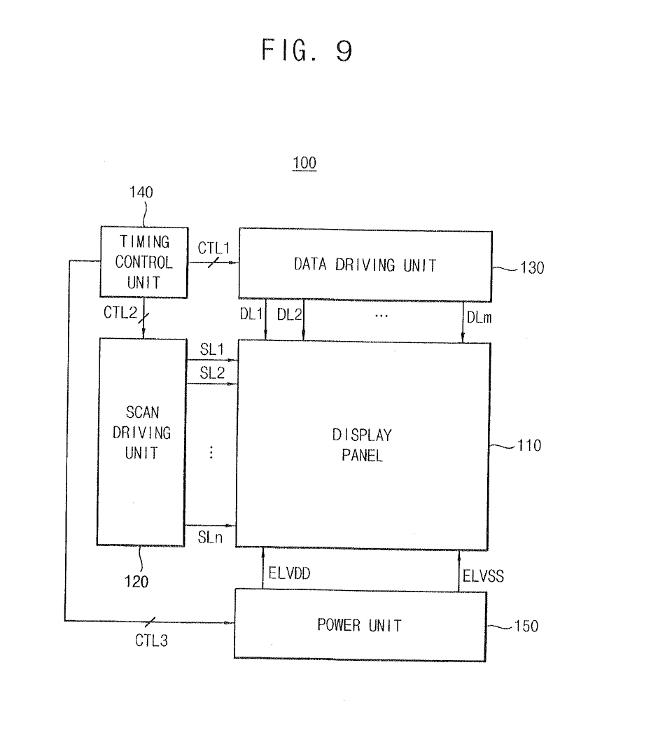

FIG. 9 is a block diagram illustrating an organic light emitting display device according to example embodiments.

Referring to FIG. 9, an organic light emitting display device 100 may employ a method of digital-driving an organic light emitting display device according to example embodiments. Here, the organic light emitting display device 100 may include a display panel 110, a scan driving unit 120, a data driving unit 130, a timing control unit 140, and a power unit 150.

The display panel 110 may include a plurality of pixels. The scan driving unit 120 may provide a scan signal to the pixels via a plurality of scan-lines SL1 through SLn. The data driving unit 130 may provide a data signal to the pixels via a plurality of data-lines DL1 through DLm. The power unit 150 may generate a first power voltage ELVDD and a second power voltage ELVSS, and may provide the first power voltage ELVDD and the second power voltage ELVSS to the pixels via a plurality of power-lines. The timing control unit 140 may generate a plurality of control signals CTL1, CTL2, and CTL3 to control the scan driving unit 120, the data driving unit 130, and the power unit 150, respectively. As described above, when the pixels emit light in the organic light emitting display device 100, one frame may be divided into a plurality of sub-frames. That is, the organic light emitting display device 100 may display one frame by displaying a plurality of sub-frames. Here, a gray level may be implemented based on a sum of emission times of the sub-frames. For this operation, the scan driving unit 120 may randomly perform scan operations of the scan-lines SL1 through SLn for each sub-frame by shifting each sub-frame scan timing of the scan-lines SL1 through SLn by a specific time, and thus may randomly (i.e., separately) perform emission operations of the scan-lines SL1 through SLn for each sub-frame. In other words, by the method of digital-driving an organic light emitting display device, a scan signal may be applied to the scan-lines SL1 through SLn in random order for each sub-frame during one frame. In addition, the scan driving unit 120 may spatially disperse emissions of the most significant bits and emissions of the least significant bits by setting a scan direction for odd scan-lines to be opposite of a scan direction for even scan-lines, or by setting a sub-frame emission order for odd scan-lines to be opposite of a sub-frame emission order for even scan-lines. Thus, a dynamic false contour noise due to an emission time difference between the most significant bits and the least significant bits may be minimized (or prevented) when a specific gray level is implemented. Although it is illustrated in FIG. 9 that the organic light emitting display device 100 includes one scan driving unit 120, the organic light emitting display device 100 may include two scan driving units. In this case, one scan driving unit may be related to the odd scan-lines, and another scan driving unit may be related to the even scan-lines.

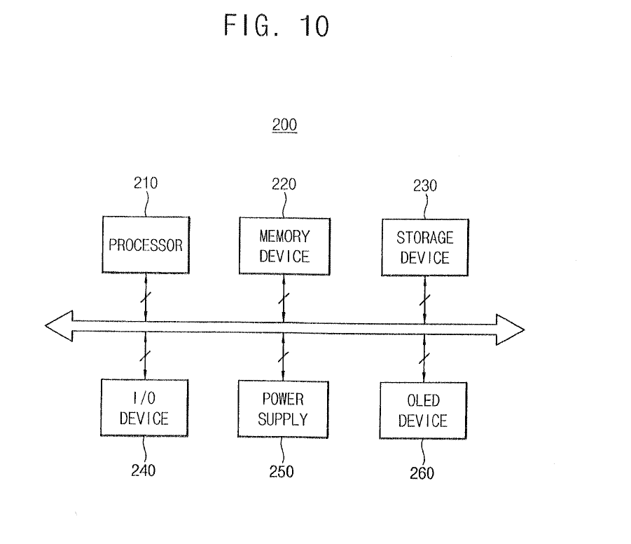

FIG. 10 is a block diagram illustrating an electric device having an organic light emitting display device of FIG. 9.

Referring to FIG. 10, an electric device 200 may include a processor 210, a memory device 220, a storage device 230, an input/output (I/O) device 240, a power supply 250, and an organic light emitting display device 260. Here, the organic light emitting display (OLED) device 260 may correspond to the organic light emitting display device 100 of FIG. 9. In addition, the electric device 200 may further include a plurality of ports for communicating a video card, a sound card, a memory card, a universal serial bus (USB) device, other electric devices, etc.

The processor 210 may perform various computing functions. The processor 210 may be a micro processor, a central processing unit (CPU), etc. The processor 210 may be coupled to other components via an address bus, a control bus, a data bus, etc. Further, the processor 210 may be coupled to an extended bus such as a peripheral component interconnection (PCI) bus. The memory device 220 may store data for operations of the electric device 200. For example, the memory device 220 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile dynamic random access memory (mobile DRAM) device, etc. The storage device 230 may be a solid state drive (SSD) device, a hard disk drive (HDD) device, a CD-ROM device, etc.

The I/O device 240 may be an input device such as a keyboard, a keypad, a mouse, a touch screen, etc, and an output device such as a printer, a speaker, etc. In some example embodiments, the organic light emitting display device 260 may be included as the output device in the I/O device 240. The power supply 250 may provide a power for operations of the electric device 200. The organic light emitting display device 260 may communicate with other components via the buses or other communication links. As described above, the organic light emitting display device 260 may spatially disperse emissions of the most significant bits and emissions of the least significant bits by setting a scan direction for odd scan-lines to be opposite of a scan direction for even scan-lines, or by setting a sub-frame emission order for odd scan-lines to be opposite of a sub-frame emission order for even scan-lines. Thus, a dynamic false contour noise due to an emission time difference between the most significant bits and the least significant bits may be minimized (or, prevented) when a specific gray level is implemented. For this operation, the organic light emitting display device 260 may include a display panel, a scan driving unit, a data driving unit, a timing control unit, and a power unit. Since the organic light emitting display device 260 is described above, duplicated descriptions will be omitted.

The present inventive concept may be applied to an electric device having an organic light emitting display device. For example, the present inventive concept may be applied to a television, a computer monitor, a laptop, a digital camera, a cellular phone, a smart phone, a personal digital assistant (PDA), a portable multimedia player (PMP), a MP3 player, a navigation system, a video phone, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of digital-driving an organic light emitting display device that divides one frame into a plurality of sub-frames, the method comprising:
setting a first order including a sub-frame emission order for odd scan-lines and a sub-frame emission order for even scan-lines;
setting a scan direction for the odd scan-lines to be a first direction;
setting a scan direction for the even scan-lines to be a second direction, the second direction being opposite of the first direction;
shifting each sub-frame scan timing of the odd scan-lines by a first time; and
shifting each sub-frame scan timing of the even scan-lines by a second time.

2. The method of claim 1, wherein each of the sub-frames corresponds to each bit of a data signal, and a gray level is implemented based on a sum of emission times of the sub-frames.

3. The method of claim 2, wherein a sub-frame having the longest emission time among the sub-frames corresponds to the most significant bit of the data signal, and a sub-frame having the shortest emission time among the sub-frames corresponds to the least significant bit of the data signal.

4. The method of claim 2, wherein the first time and the second time are determined to spatially disperse emissions of sub-frames corresponding to the most significant hits of the data signal and emissions of sub-frames corresponding to the least significant bits of the data signal, respectively.

5. The method of claim 4, wherein the first time is substantially the same as the second time.

6. The method of claim 4, wherein the first time is different from the second time.

7. The method of claim 2, wherein the first direction is determined from an upper scan-line to a lower scan-line in the organic light emitting display device, and the second direction is determined from the lower scan-line to the upper scan-line in the organic light emitting display device.

8. The method of claim 2, wherein the first direction is determined from a lower scan-line to an upper scan-line in the organic light emitting display device, and the second direction is determined from the upper scan-line to the lower scan-line in the organic light emitting display device.

9. The method of claim 2, wherein the first order is determined in order of increasing of the emission times of the sub-frames.

10. The method of claim 2, wherein the first order is determined in order of decreasing of the emission times of the sub-frames.

11. A method of digital-driving an organic light emitting display device that divides one frame into a plurality of sub-frames, the method comprising:
setting a scan direction for odd scan-lines and a scan direction for even scan-lines to be a first direction;
setting a sub-frame emission order for the odd scan-lines to be a first order;
setting a sub-frame emission order for the even scan-lines to be a second direction, the second direction being opposite of the first direction;
shifting each sub-frame scan timing of the odd scan-lines by a first time; and
shifting each sub-frame scan timing of the even scan-lines by a second time.

12. The method of claim 11, wherein each of the sub-frames corresponds to each bit of a data signal, and a gray level is implemented based on a sum of emission times of the sub-frames.

13. The method of claim 12, wherein a sub-frame having the longest emission time among the sub-frames corresponds to the most significant bit of the data signal, and a sub-frame having the shortest emission time among the sub-frames corresponds to the least significant bit of the data signal.

14. The method of claim 12, wherein the first time and the second time are determined to spatially disperse emissions of sub-frames corresponding to the most significant bits of the data signal and emissions of sub-frames corresponding to the least significant bits of the data signal, respectively.

15. The method of claim 14, wherein the first time is substantially the same as the second time.

16. The method of claim 14, wherein the first time is different from the second time.

17. The method of claim 12, wherein the first order is determined in order of increasing of the emission times of the sub-frames, and the second order is determined in order of decreasing of the emission times of the sub-frames.

18. The method of claim 12, wherein the first order is determined in order of decreasing of the emission times of the sub-frames, and the second order is determined in order of increasing of the emission times of the sub-frames.

19. The method of claim 12, wherein the first direction is determined from an upper scan-line to a lower scan-line in the organic light emitting display device.

20. The method of claim 12, wherein the first direction is determined from a lower scan-line to an upper scan-line in the organic light emitting display device.
